(19) United States
(12) Patent Application Publication
(10) Pub. No.: US 2018/0001464 A1
(43) Pub. Date: Jan. 4, 2018

(54) CUFF LINK TOOL

(71) Applicants: Christopher Scott FREDERICK, Spotsylvania, VA (US); Jeffery Wayne MORIN, Bumpass, VA (US)

(72) Inventors: Christopher Scott FREDERICK, Spotsylvania, VA (US); Jeffery Wayne MORIN, Bumpass, VA (US)

(21) Appl. No.: 15/196,336

(22) Filed: Jun. 29, 2016

(51) Int. Cl. B25F 1/04; A44B 5/00; B25B 15/00

(52) U.S. Cl. CPC B25F 1/04; B25B 15/007; A44B 5/002; B25B 15/005

(57) ABSTRACT

A cuff link that doubles as a multipurpose tool is provided, wherein the multipurpose tool provides both screwdriver and bottle opener functionality. The cuff link tool has a head plat perpendicularly joined to two spaced apart bracket members. Between the two spaced apart bracket members a link post is pivotally connected about an axle that extends between the distal ends of the two spaced apart bracket members. So not only can the link post operate as such, because terminates in a screwdriver interface, can be used as a screwdriver when a user rotates the head plat. An off-center notch is provided in the head plat, so that it too may be discretely used as a bottle opener.

### BACKGROUND OF THE INVENTION

The present invention relates to cuff links and, more particularly, to a cuff link that doubles as a multipurpose tool.

Many bottles are hard to open without a bottle opener and screws are almost impossible to loosen or tighten by hand without a screwdriver. There are many situations and times where people are lacking these requisite tools, including during formal settings. In such formal settings, while wearing formal attire, carrying a normal bottle opener, screw driver, or both would require placing at least one large, bulky tool in a formal attire pocket not adapted for supporting tools or that is puncture proof. Furthermore, the resulting bulkiness of carrying such tools, or even the mere presence of such tools, may look uncouth in a formal setting.

As can be seen, there is a need for a cuff link that doubles as a multipurpose tool, wherein the multipurpose tool provides both a philips and/or flathead screwdriver as well as a bottle opener, so that a user can discreetly provide such tools in a formal setting.

### SUMMARY OF THE INVENTION

In one aspect of the present invention, a cuff link tool includes a head plat having an outward surface and an opposing inward surface; two spaced apart bracket members joined to the inward surface; an axle extending between a distal end of each bracket member; a link post extending from a first end to a second end, wherein the link post is pivotally connected about the axle between the first and second ends; and a screwdriver interface provided on the first end.

In another aspect of the present invention, the cuff link tool includes a head plat having an outward surface and an opposing inward surface, both surfaces defined by two longitudinal edges; two spaced apart bracket members joined to the inward surface; an axle extending between a distal end of each bracket member; a link post extending from a first end to a second end, wherein the link post is pivotally connected about the axle between the first and second ends; a screwdriver interface provided on the first end; and a leverage notch provided along one of the two longitudinal edges of the head plat, wherein the leverage notch is oriented at an acute angle relative to said longitudinal edge, and wherein a distance between the axle and the screwdriver interface is greater than a distance between the second end and the axle by approximately 20 to 50 percent.

In yet another aspect of the present invention, the cuff link tool includes a head plat having an outward surface and an opposing inward surface, both surfaces defined by two longitudinal edges; two spaced apart bracket members joined to the inward surface; an axle extending between a distal end of each bracket member; a link post extending from a first end to a second end, wherein the link post is pivotally connected about the axle between the first and second ends; a screwdriver interface provided on each the first end and the second end; and a leverage notch provided along one of the two longitudinal edges of the head plat, wherein the leverage notch is oriented at an acute angle relative to said longitudinal edge.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention, shown in use;

FIG. 2 is top perspective view of an exemplary embodiment of the present invention;

FIG. 3 is a bottom perspective view of an exemplary embodiment of the present invention;

FIG. 4 is a bottom perspective view of an exemplary embodiment of the present invention;

FIG. 5 is a section view of an exemplary embodiment of the present invention, taken along line 5-5 of FIG. 2;

FIG. 6 is a section view of an exemplary embodiment of the present invention, taken along line 6-6 of FIG. 4;

FIG. 7 is a section detail view of an exemplary embodiment of the present invention, taken along line 7-7 of FIG. 1;

FIG. 8 is an exploded view of an exemplary embodiment of the present invention, shown in use as a screw driver;

FIG. 9 is perspective view of an exemplary embodiment of the present invention, shown in use as a screw driver;

FIG. 10 is a bottom perspective view of an exemplary embodiment of the present invention, shown in use as a bottle opener;

FIG. 11 is a perspective view of an exemplary embodiment of the present invention, shown in use as a bottle opener;

FIG. 12 is top perspective view of an exemplary embodiment of the present invention; and

FIG. 13 is a bottom perspective view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a cuff link that doubles as a multipurpose tool, wherein the multipurpose tool provides both screwdriver and bottle opener functionality. The cuff link tool has a head plat perpendicularly joined to two spaced apart bracket members. Between the two spaced apart bracket members a link post is pivotally connected about an axle that extends between the distal ends of the two spaced apart bracket members. So not only can the link post operate as such, because terminates in a screwdriver interface, can be used as a screwdriver when a user rotates the head plat. An off-center notch is provided in the head plat, so that it too may be discretely used as a bottle opener.

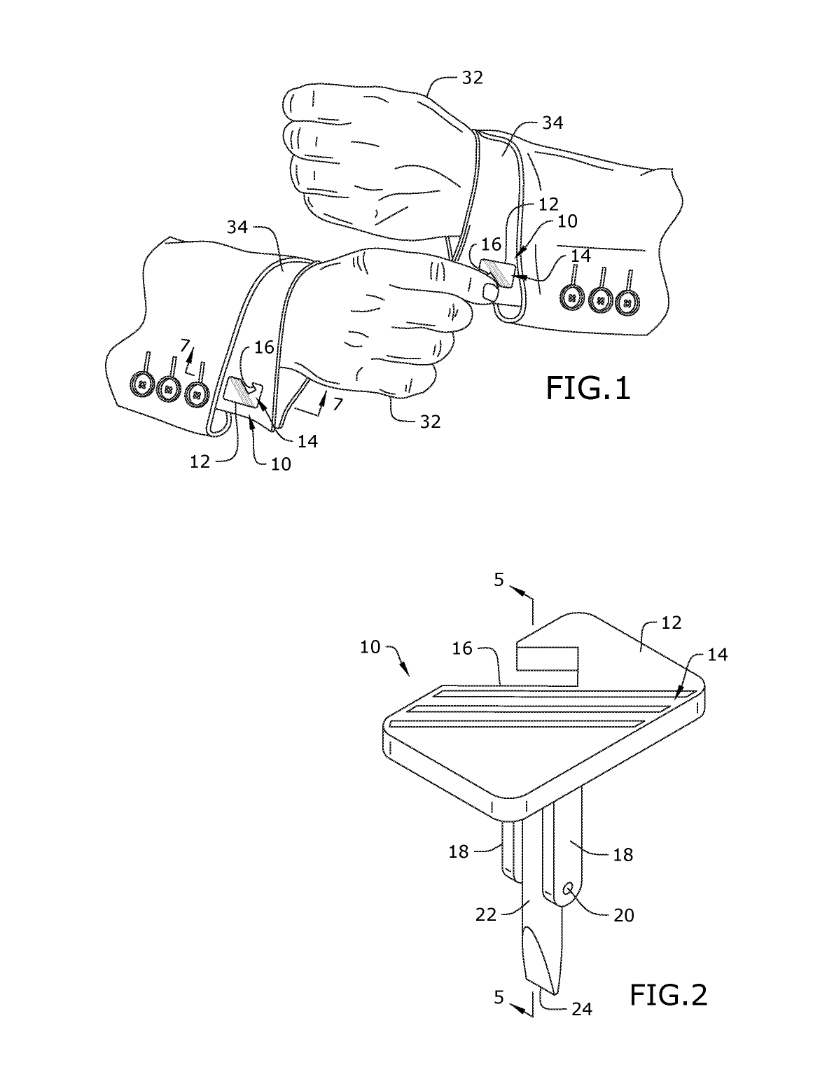

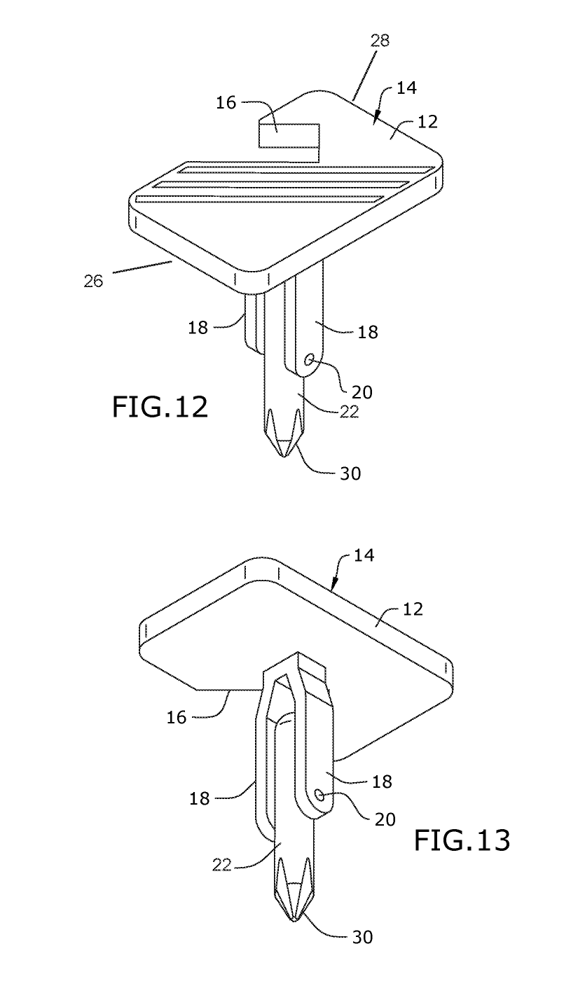

Referring to FIGS. 1 through 13, the present invention may include a cuff link tool 10. The cuff link tool 10 may include a head plat 12 having an inward surface 11 and an opposing outward surface 14. A suitable ornamental design may be disposed on the outward surface 14, as illustrated in FIG. 1. Two spaced apart bracket members 18 may be joined to the inward surface 11, in certain embodiments generally perpendicularly joined thereto, as illustrated in FIG. 2. Each bracket member 18 may extend from a proximal end joined to the inward surface 11 to a distal end. A link post 2 may be pivotally connected between the two spaced apart bracket members 18 about an axle 20, wherein the axle 20 extends between the two spaced apart bracket members 18, as illustrated in FIG. 2.

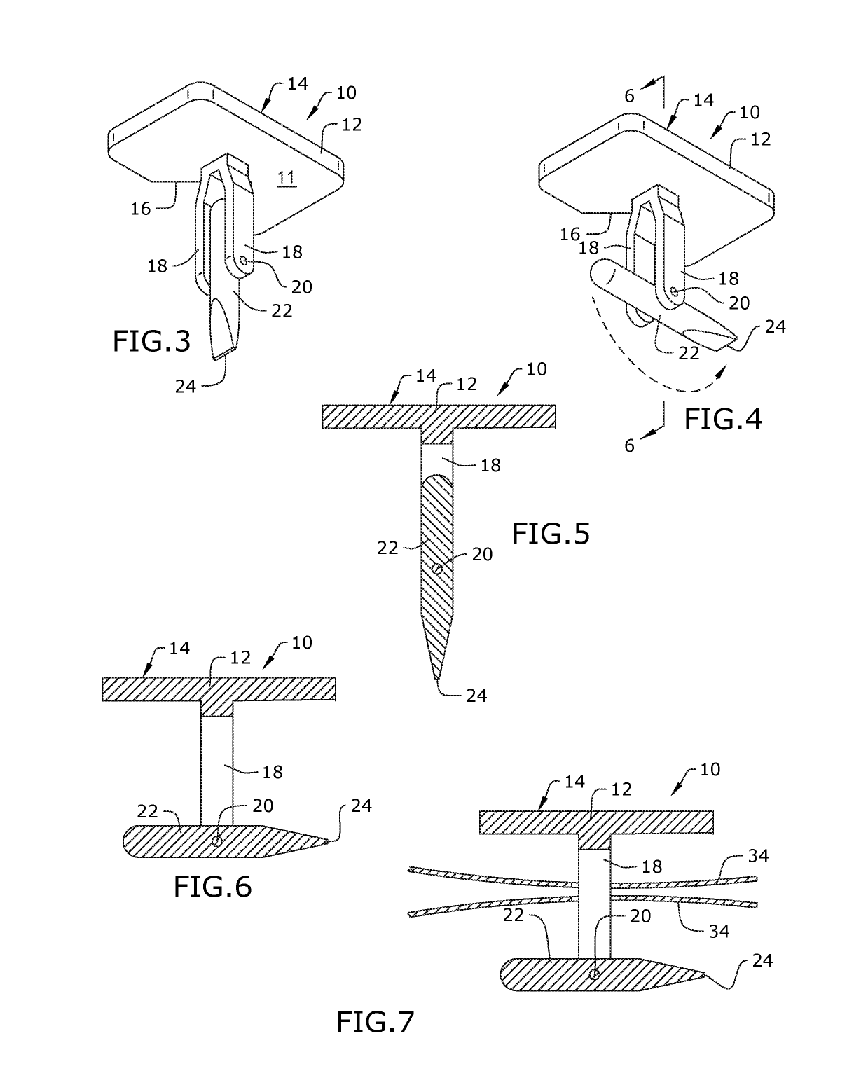

The link post 22 may be dimensioned so as to protrude beyond the distal end of the bracket members 18 in a coaxial orientation, as illustrated in the FIGS. 2 and 3. Thereby, the link post 20 may be used as a standard link post 22, in the coaxial orientation, to pass through at least two layered button holes of apparel 34, and then pivot ninety degrees, in a parallel orientation, so that the two layers of apparel 34 are interconnected by the bracket members 18, while the orthogonally-oriented link post 22 secures such interconnection, as illustrated in FIG. 7.

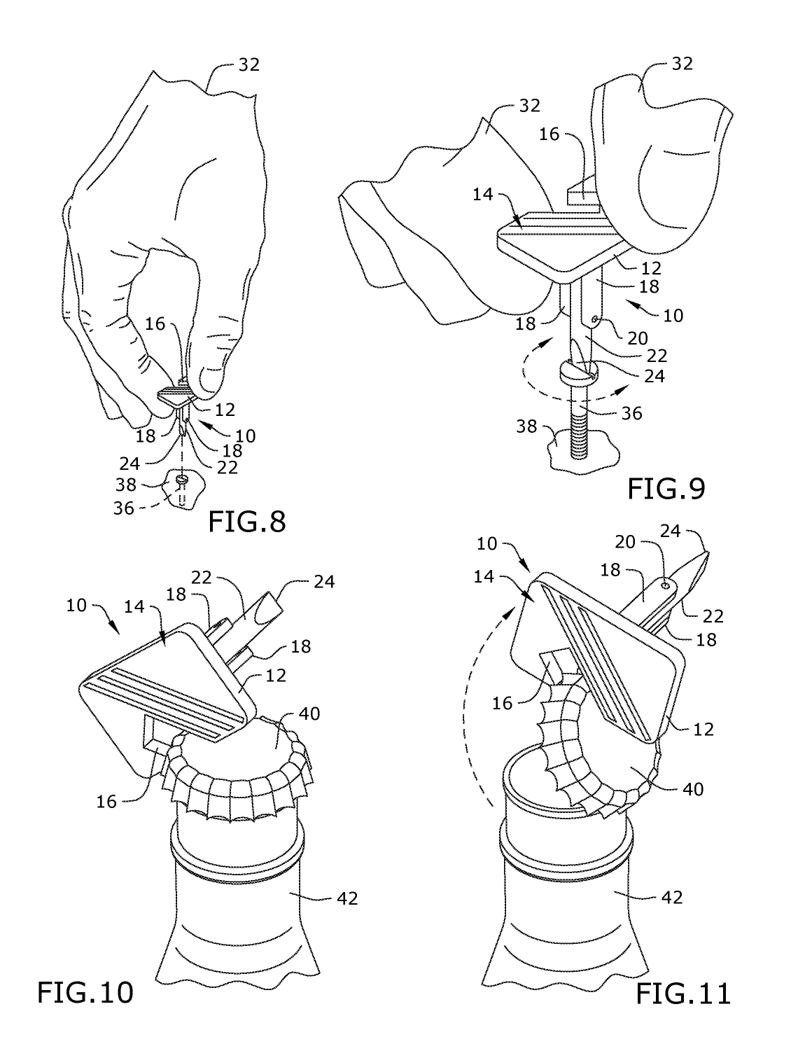

The link post 22 may be an elongated member that extends along its longitudinal axis from a first end 24 to a second end 30. The first end 24 may provide a flathead screwdriver interface, and the second end 30 may provide a phillips-head screwdriver interface, where the flathead and phillips-head screwdriver interfaces are dimensioned and adapted to operatively engage flathead and phillips-head screw head, as illustrated in FIGS. 8 and 9 (for the flathead). In certain embodiments, only one end 24 or 30 will form a screwdriver interface. In such embodiments, the link post may be pivotally connected via the axle 20 offset from a link post midpoint, so that a distance from the screwdriver interface end to the axle 20 will be greater than a distance from the axle 20 to the opposing (non-screwdriver interface) end. The difference between such differences may range from 20 to 50 percent. This additional distance or elongation of the screwdriver interface end facilitates greater leverage and torque when being operatively used as a screwdriver, as illustrated in FIG. 9.

The head plat 12 may be elongated as it extends along its longitudinal edges from a first edge 26 to an opposing second edge 28. A leverage notch 16 may be provided by one of its longitudinal edges so as to form a rectangular void that extends along an acute angle relative to said longitudinal edge, as illustrated in FIG. 2. In certain embodiments, the leverage notch 16 may be provided by the first or second edge 26, 28, or along one of the longitudinal edges, but closer to the corner formed by the intersection of a first or second edge 26, 28 and a longitudinal edge. In an alternative embodiment, the notch 16 may be provide by said corner extending toward a center point of the head plat 12 or nearby. The acute angle may be approximately 45 degrees. Such orientation of the leverage notch 16 affords a user 32 greater leverage/torque when using the leverage notch 16 to remove a bottle cap 40 from a bottle 42.

A method of using the present invention may include the following. The cuff link tool 10 disclosed above may be provided. The user 32 could operate the cuff link tool 10 as a standard cuff link, as illustrated in FIGS. 1 and 7. However, when the user 32 needs to open a bottle cap 42, the head plat 12 and/or the bracket members 18 may be manipulated to pry the bottle cap 42 off, as illustrated in FIGS. 10-11. When the user 32 needs to screw a screw 36 into an object 38, the user 32 may manipulate the head plat 12 to selectively rotate the link post 22 in the coaxial orientation as the screwdriver interface 24 or 30 engages the screw's 36 head, as illustrated in FIGS. 8 and 9.

It should be understood, of course, that the foregoing relates to exemplary embodiments of the invention and that modifications may be made without departing from the spirit and scope of the invention as set forth in the following claims.

What is claimed is:

1. A device, comprising:
a head plat having an outward surface and an opposing inward surface;
two spaced apart bracket members joined to the inward surface;
an axle extending between a distal end of each bracket member;
a link post extending from a first end to a second end, wherein the link post is pivotally connected about the axle between the first and second ends; and
a screwdriver interface provided on the first end.

2. The device of claim 1, wherein a distance between the axle and the screwdriver interface is greater than a distance between the second end and the axle by approximately 20 to 50 percent.

3. The device of claim 1, wherein the screwdriver interface is a flathead.

4. The device of claim 1, wherein the screwdriver interface is a phillips head.

5. The device of claim 1, further comprising a screwdriver interface on the second end.

6. The device of claim 1, further comprising a leverage notch provided along a longitudinal edge of the head plat, wherein the leverage notch is oriented at an acute angle relative to said longitudinal edge.

7. The device of claim 6, wherein said longitudinal edge extends from a first edge to a second edge, and wherein the leverage notch forms a rectangular void that terminates closer to the first edge than to the second edge.

8. A device, comprising:
a head plat having an outward surface and an opposing inward surface, both surfaces defined by two longitudinal edges;
two spaced apart bracket members joined to the inward surface;
an axle extending between a distal end of each bracket member;
a link post extending from a first end to a second end, wherein the link post is pivotally connected about the axle between the first and second ends;
a screwdriver interface provided on the first end; and
a leverage notch provided along one of the two longitudinal edges of the head plat, wherein the leverage notch is oriented at an acute angle relative to said longitudinal edge, and
wherein a distance between the axle and the screwdriver interface is greater than a distance between the second end and the axle by approximately 20 to 50 percent.

9. The device of claim 8, wherein the screwdriver interface is a flathead.

10. The device of claim 8, wherein the screwdriver interface is a phillips head.

11. A device, comprising:
a head plat having an outward surface and an opposing inward surface, both surfaces defined by two longitudinal edges;
two spaced apart bracket members joined to the inward surface;
an axle extending between a distal end of each bracket member;
a link post extending from a first end to a second end, wherein the link post is pivotally connected about the axle between the first and second ends;
a screwdriver interface provided on each the first end and the second end; and
a leverage notch provided along one of the two longitudinal edges of the head plat, wherein the leverage notch is oriented at an acute angle relative to said longitudinal edge.
